(19) United States
(12) Patent Application Publication
(10) Pub. No.: US 2023/0419271 A1
(43) Pub. Date: Dec. 28, 2023

(54) ROUTING FIELD SUPPORT TO VEHICLES FOR MAINTENANCE

(71) Applicant: GM Cruise Holdings LLC, San Francisco, CA (US)

(72) Inventors: Christopher Warren, Seattle, WA (US); Vinayaka Dattatraya, Mill Creek, WA (US); Daniel Paul Thengvall, San Francisco, CA (US); MinJie Tong, Issaquah, WA (US); Theresa Foy, San Francisco, CA (US); Leah Meyerholtz, San Francisco, CA (US); Alexander Hudson Case, San Francisco, CA (US); Ashley Sams, San Francisco, CA (US)

(73) Assignee: GM Cruise Holdings LLC, San Francisco, CA (US)

(21) Appl. No.: 17/849,396

(22) Filed: Jun. 24, 2022

(51) Int. Cl. G06Q 10/00; G07C 5/00; G07C 5/08; G08G 1/00

(52) U.S. Cl. CPC G06Q 10/20; G07C 5/008; G07C 5/0808; G08G 1/202

(57) ABSTRACT

Systems and methods are provided for recovery of autonomous vehicles. In particular, systems and methods are provided for vehicle recovery prioritization in a fleet of vehicles when multiple vehicles request recovery. A vehicle recovery event is generated for vehicles in need of recovery based on the vehicle's sensor log. The recovery service type is determined based on the vehicle recovery event, and vehicles in need of recovery are prioritized based on the recovery service type and the vehicle recovery event. The recovery support can include a recovery support representative and/or a recovery support service technician. Recovery response can be based on the recovery prioritization. Vehicle sensors and computing power can be used to inform onboard processors and/or central computers of a risk profile for the vehicle, and dispatch can trigger a response plan according to a recovery response framework.

### FIELD OF THE DISCLOSURE

The present disclosure relates generally to autonomous vehicles (AVs) and to systems and methods for vehicle maintenance.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Autonomous vehicles can be part of an autonomous vehicle fleet that provides rides to users and/or picks up and delivers packages. Sometimes, an autonomous vehicle can be in need of manual recovery. For example, a vehicle may break down, or a vehicle may be hit by another vehicle. In various scenarios, a representative of the autonomous vehicle fleet may need to be dispatched to recover an autonomous vehicle.

### SUMMARY

Systems and methods are provided for recovery of autonomous vehicles. In particular, systems and methods are provided for converting vehicle sensor logs into vehicle recovery events. When a vehicle is in need of recovery, vehicle sensor logs are converted to vehicle recovery events, and the vehicle recovery events can be used to assign appropriate recovery support. The recovery support can include a recovery support representative and/or a recovery support service technician. When a vehicle is in need of physical recovery, the appropriate support service technician can be selected based on the vehicle recovery event submission.

According to one aspect, a method for vehicle recovery comprises: determining a vehicle is in need of recovery; generating a vehicle recovery event based on a vehicle sensor log; determining a recovery service type based on the vehicle recovery event; determining a recovery prioritization for the vehicle based on the vehicle recovery event; and assigning a field support technician based on the recovery service type and the recovery prioritization.

In some implementations, the method further comprises determining recovery prioritization based on the vehicle sensor log. In some implementations, the vehicle sensor log includes vehicle sensor data, and further comprising determining a risk profile for the vehicle based on the vehicle sensor data. In some implementations, the vehicle sensor data includes at least one of a presence of passengers in the first vehicle, a speed of other road users, a distance between the vehicle and other road users, road conditions, and weather conditions. In some implementations, determining the recovery prioritization includes determining the recovery prioritization based on the risk profile. In some implementations, determining the recovery prioritization for the vehicle includes determining the recovery prioritization based on the recovery service type. In some implementations, determining the recovery prioritization for the vehicle includes providing a rank for recovery to each of a plurality of stranded vehicles in a fleet, wherein the vehicle is one of the plurality of stranded vehicles.

In some implementations, generating the vehicle recovery event based on the vehicle sensor log includes generating the vehicle recovery event at an onboard computer on the vehicle, and further comprising transmitting the vehicle recovery event to a dispatch service. In some implementations, generating the vehicle recovery event based on the vehicle sensor log includes receiving the vehicle sensor log at a central computer, generating the vehicle recovery event at the central computer, and further comprising transmitting the vehicle recovery event to a dispatch service.

According to another aspect, a system for vehicle recovery in a fleet of vehicles, comprises: a first vehicle in the fleet, including: a sensor suite including external vehicle sensors to sense a vehicle environment and generate sensor data; a vehicle sensor log to log sensor data; an onboard computer to transmit the vehicle sensor log; and a dispatch service to: identify a recovery service type for the first vehicle based on a vehicle recovery event; determine a recovery prioritization for the first vehicle based on the vehicle recovery event and the recovery service type; and assign a field support technician based on the recovery service type and the recovery prioritization.

In some implementations, the first vehicle onboard computer is to generate the vehicle recovery event from the vehicle sensor log and transmit the vehicle recovery event to the dispatch service. In some implementations, the system further comprises a central computer to receive the vehicle sensor log, generate the vehicle recovery event based on the vehicle sensor log, and transmit the vehicle recovery event to the dispatch service. In some implementations, the vehicle sensor data includes at least one of a presence of passengers in the first vehicle, a speed of other road users, a distance between the vehicle and other road users, road conditions, and weather conditions. In some implementations, the dispatch service is further to determine a risk profile for the first vehicle based on the vehicle sensor data and wherein the recovery prioritization is based on the risk profile. In some implementations, the dispatch service is further to provide a rank for recovery to each of a plurality of stranded vehicles in the fleet, wherein the first vehicle is one of the plurality of stranded vehicles.

According to another example, a system for system for vehicle recovery in a vehicle fleet, comprises: a plurality of vehicles, each vehicle including: a sensor suite including external vehicle sensors to sense a vehicle environment and generate sensor data; a vehicle sensor log to log sensor data; an onboard computer to transmit the vehicle sensor log; and a dispatch service to: identify a recovery service type for each of a set of stranded vehicles, wherein the recovery service type is based on a vehicle recovery event for each of the set of stranded vehicles, and wherein the plurality of vehicles includes the set of stranded vehicles; determine a recovery prioritization based on the respective vehicle recovery event for each of the set of stranded vehicles; and assign a field support technician to each of the set of stranded vehicles based on the recovery service type and the recovery prioritization.

In some implementations, for each of the set of stranded vehicles, the onboard computer is to generate the vehicle recovery event based on the vehicle sensor log. In some implementations, the system further comprises a central computer to, for each of the set of stranded vehicles, receive the vehicle sensor log, generate the vehicle recovery event based on the vehicle sensor log, and transmit the vehicle recovery event to the dispatch service. In some implementations, the dispatch service is further to provide a rank for recovery to each of the set of stranded vehicles, and wherein the recovery prioritization is based on the rank. In some implementations, for each of the plurality of vehicles, the sensor data includes at least one of a presence of passengers in the respective vehicle, a speed of other road users around the respective vehicle, a distance between the respective vehicle and other road users, road conditions, and weather conditions at the respective vehicle, and wherein the dispatch service is further to determine a risk profile for each of the set of stranded vehicle based on the respective sensor data.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a diagram illustrating a method for creating a vehicle recovery event, according to some embodiments of the disclosure;

FIGS. 3A and 3B are diagrams illustrating a system for creating vehicle recovery events and for recovery prioritization in a vehicle fleet, according to some embodiments of the disclosure;

FIG. 4 is a diagram illustrating a stranded vehicle for recovery prioritization, according to some embodiments of the disclosure;

FIG. 5 is another diagram illustrating a stranded vehicle for recovery prioritization, according to some embodiments of the disclosure;

FIG. 6 is a diagram illustrating a fleet of autonomous vehicles in communication with a central computer, according to some embodiments of the disclosure; and

FIG. 7 shows an example embodiment of a system for implementing certain aspects of the present technology.

### DETAILED DESCRIPTION

### Overview

Systems and methods are provided for recovery of autonomous vehicles. In particular, systems and methods are provided for converting vehicle sensor logs into vehicle recovery events. When a vehicle is in need of recovery, vehicle sensor logs are converted to vehicle recovery events, and the vehicle recovery events can be used to assign appropriate recovery support. The recovery support can include a recovery support representative and/or a recovery support service technician. When a vehicle is in need of physical recovery, the appropriate support service technician can be selected based on the vehicle recovery event submission. In some examples, stranded vehicles in need of recovery are assigned a risk profile and prioritized based on the risk profile based on the corresponding vehicle recovery event record. Additionally, the risk profile can be based on a number of factors, such as a risk level for the vehicle due to the vehicle's situation, the presence of passengers in the vehicle, and congestion caused by the vehicle. Recovery response can be based on the recovery prioritization. Vehicle sensors and computing systems can be used to sense the environment of the vehicle, inform onboard processors and/or central computers of a risk profile for the vehicle, and update a vehicle recovery event submission.

When a large fleet of autonomous vehicles is deployed, e.g., in an urban or extra urban area, it is likely that multiple vehicles may need to be recovered at the same time. Recovery usually includes manual intervention, but, in some examples, a vehicle may be recovered autonomously using another vehicle. In some cases, when multiple vehicles are in need of recovery simultaneously, the process includes manual prioritization. For example, support members are located in assigned areas throughout a city, ready to evaluate situations that arise and prioritize any recoveries that are requested at (or around) the same time. However, the manual vehicle recovery prioritization process is not easily scalable, and as vehicle fleets grow, the manual process becomes ineffective.

If vehicles are recovered based on time of recovery notification, some vehicles may be stranded in hazardous situations while vehicles in non-hazardous situations are prioritized. A hazardous situation can include a public road in a high traffic impedance area, such as in an intersection or in an opposite traffic lane. Leaving a vehicle stuck in a hazardous situation can increase the risk of collision between the stranded vehicle and another vehicle. Thus, systems and methods are provided herein for using a vehicle's sensor log to create a vehicle recovery event, where the sensor log and thus the vehicle recovery event information can be used to determine the type of service needed for recovery, thereby expediting the recovery process.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Example Autonomous Vehicle Configured for Recovery Prioritization

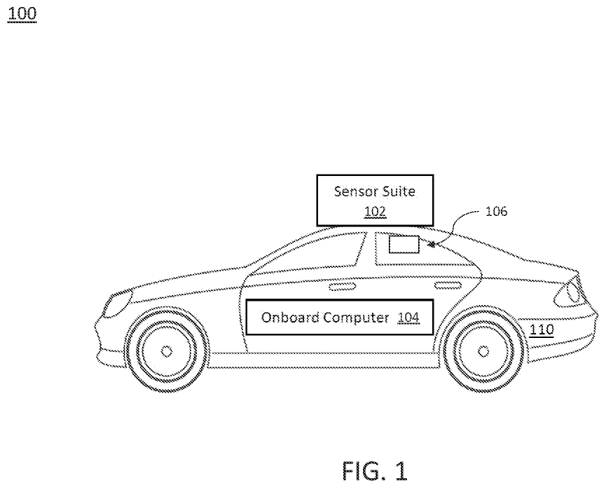

FIG. 1 is a diagram of an autonomous driving system 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. In some examples, the autonomous vehicle 110 includes systems and methods for transmitting its vehicle sensor log if it becomes stranded and in need of recovery. In some examples, the autonomous vehicle 110 includes systems and methods for generating a vehicle recovery event from its vehicle sensor log if it becomes stranded and in need of recovery. In some examples, the autonomous vehicle 110 includes a vehicle sensor log 106 that logs vehicle sensor data, which can be used to generate a vehicle recovery event when a vehicle is in need of recovery.

The sensor suite 102 includes localization and driving sensors. For example, the sensor suite may include one or more of photodetectors, cameras, radio detection and ranging (RADAR), sound navigation and ranging (SONAR), light detection and ranging (LIDAR), GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. As described in greater detail below, information about the autonomous vehicle's environment as detected by the sensor suite 102 can be logged in a vehicle sensor log, which can be used to generate a vehicle recovery event as provided herein. In particular, the sensor suite 102 can be used to identify information and determine various factors regarding an autonomous vehicle's environment. In some examples, data from the sensor suite 102 can be used to update a map with information used to develop layers with waypoints identifying various detected items. In some examples, data from the sensor suite 102 can include information regarding crowds and/or lines outside and/or around selected venues. The data and map waypoints can be used by the recovery prioritization system in determining a risk profile of a stranded vehicle. Additionally, sensor suite 102 data can provide localized traffic information. In this way, sensor suite 102 data from many autonomous vehicles can continually provide feedback to the mapping system and the high fidelity map can be updated as more and more information is gathered. In some examples, the recovery prioritization system provided herein can use information gathered by other autonomous vehicles in the fleet, for example information in the mapping system, for updating risk profile of a stranded vehicle as described in greater detail below. Additionally, the vehicle 110 includes various impact sensors, which can be located on the vehicle exterior and in the sensor suite 102.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some examples, a vehicle sensor log receives and stores processed sensed sensor suite 102 data from the onboard computer 104. In some examples, a vehicle sensor log receives sensor suite 102 data from the sensor suite 102. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. The presence of passengers inside the vehicle can be included in a determining a priority assignment for a stranded vehicle, as described in greater detail below. Additionally, based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Method for Creating a Vehicle Recovery Event

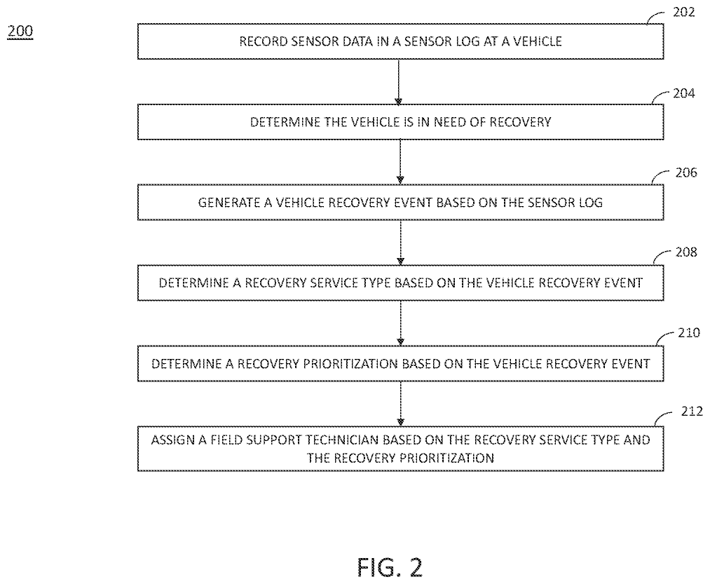

FIG. 2 is a diagram illustrating a method 200 for creating a vehicle recovery event, according to some embodiments of the disclosure. According to various examples, the method 200 begins at step 202, when sensor data is recorded in a sensor log on a vehicle. In various examples, vehicle sensor data is continuously and/or periodically stored and/or updated in a sensor log on the vehicle. Sensor data stored in the sensor log can include vehicle location, vehicle direction of travel, number of passengers in the vehicle, surrounding traffic conditions, presence of pedestrians, road conditions, weather conditions, visibility, as well as data such as vehicle speed, mileage, tire pressure, battery charge, engine conditions, temperatures (outside, interior cabin, battery, engine, etc.), and sensor data indicating any external contact with the vehicle. The sensor log can include a last known state and a buffer of sensor data for a selected period of time (e.g., last 30 seconds) before the last known state. In some examples, the vehicle can include a black box recorder and/or the sensor log can act as a black box recorder. In some examples, the first vehicle periodically updates this information, such as every second, every five seconds, or any time there is any change to the vehicle (e.g., the vehicle is moved, bumped, etc.).

At step 204, it is determined that the vehicle is in need of recovery. In general, when an autonomous vehicle is in need of recovery, it cannot or does not continue to drive autonomously. In some examples, a vehicle in need of recovery has a flat tire. In some examples, a vehicle in need of recovery includes degraded sensors and/or other degraded components. In some examples, a vehicle in need of recovery has experienced a hardware failure, a software failure, and/or a loss of critical data for operation (such as a loss of map data). In some examples, a vehicle may be in need of recovery following a collision with another road user. In some examples, abnormal driving conditions, abnormal road conditions, and/or other anomalies may cause a vehicle to become stranded and in need of recovery. A vehicle in need of recovery may request recovery, for example, by communicating with a central computer. In other examples, a vehicle in need of recovery may be unable to request recovery.

In various implementations, determining that the vehicle is in need of recovery can occur either at the vehicle or in a central computer and/or cloud. For instance, the vehicle can include a failsafe computer system that can perform the determination that the vehicle is in need of recovery. In another example, the vehicle can transmit an emergency signal (e.g., an “SOS” signal) to a central computer and/or cloud, which can determine that the vehicle is in need of recovery. In some examples, an onboard computer system implements a decision tree to determine that the vehicle is in need of recovery. Similarly, a central computer can implement a decision tree to determine that a vehicle is in need of recovery.

At step 206, a vehicle recovery event is generated based on the vehicle sensor log from step 202. In some examples, the vehicle recovery event includes vehicle sensor log data as well as a recovery request. In some examples, the vehicle recovery event includes a subset of vehicle sensor log data as well as a recovery request.

In some examples, the vehicle recovery event is generated on the vehicle and is transmitted to a central computer and/or dispatch service. In some examples, the central computer and/or dispatch service receives the vehicle sensor log and generates the vehicle recovery event based on the vehicle sensor log. Thus, step 206 can include retrieving information from a sensor log that was transmitted before the vehicle became stranded and in need of recovery. In some examples, the vehicle sensor log is updated when the vehicle becomes stranded and in need of recovery. In some examples, the vehicle sensor log is updated after the vehicle becomes stranded and in need of recovery, and the vehicle sensor log can include information such any sensed damage to the first vehicle and whether airbags deployed in the first vehicle. In some examples, the vehicle sensor log is periodically updated after the vehicle becomes stranded and in need of recovery. In some examples, a vehicle in need of recovery may shut down and not be able to log information after an incident that caused the shutdown.

In various examples, as described above, either the vehicle sensor log and/or the vehicle recovery event is transmitted to a central computer and/or a dispatch service. In some examples, when the vehicle information is updated, the vehicle communicates the updated information with a central computer and/or a dispatch service. However, in some examples, a vehicle in need of recovery may shut down and not communicate with a central computer and/or a dispatch service. For instance, vehicle sensors can be degraded and unable to sense the vehicle environment. In another example, a vehicle may experience a loss of power. In another example, a vehicle may experience a loss of a data communication channel. In another example, a vehicle may experience another system failure that prevents the vehicle from communicating with a central computer and/or a dispatch service. In some examples, a passenger mobile device may be used to communicate with a central computer and/or a dispatch service. For instance, if there is a loss of a communication channel, and the passenger's mobile device is connected to a vehicle's communication system (e.g., via USB, WiFi, and/or Bluetooth), the vehicle may use the passenger's mobile device to communicate with a central computer and/or a dispatch service. In some examples, the vehicle may ask for permission from the passenger to use the passenger's mobile device to communicate with the central computer and/or the dispatch service.

At step 208, the type of recovery service needed to recover the vehicle is determined based on the vehicle recovery event. In various examples, the recovery service can include a remote recovery service personnel, an on-site field support representative, a service technician, a service vehicle, a tow truck, and emergency personnel such as police and/or medical personnel. Additionally, if there are one or more passengers in a vehicle in need of recovery, the recovery service can include a request for another vehicle to provide ride(s) to the passenger(s) to their destinations.

In some examples, if the vehicle recovery event indicates that the vehicle has a flat tire, the recovery service may include a service technician who can change the vehicle tire. Once the tire is replaced, the vehicle can drive to a service center for maintenance. In another example, if the vehicle recovery event indicates that the vehicle battery is empty, the recovery service may include a mobile charger to charge the vehicle battery sufficiently for the vehicle to drive to a charging station. In some examples, if the vehicle recovery event indicates a software failure, the recovery service may include an on-the-spot software update (e.g., provided by a service technician). The vehicle may similarly then drive to a service center for maintenance. In some examples, the vehicle recovery event may indicate a loss of map data and/or a failure to load maps. If the stranded vehicle is able to communicate with a nearby vehicle to receive map and routing information, the recovery service may include another vehicle to guide the stranded vehicle to a service center. Similarly, in some examples, the vehicle recovery event may indicate a communication channel failure, such that the vehicle is unable to communicate with a central computer and/or dispatch service. If the stranded vehicle is able to communicate with a nearby vehicle, the recovery service may include another vehicle to guide the stranded vehicle to a service center. In other examples, (e.g., if the stranded vehicle has experienced a complete communicate channel failure), the recovery service may include a tow truck to tow the vehicle to a service center. Similarly, if the vehicle recovery event indicates degraded sensors, a hardware failure, or another autonomous vehicle fault, the recovery service may include a tow truck to tow the vehicle to a service center for repair and/or maintenance.

In other examples, if the vehicle recovery event indicates the vehicle was involved in a collision, and the recovery service may include interacting with emergency personnel. If the collision was a minor collision with no vehicle damage or injuries, the recovery service can be performed remotely, through vehicle sensors, speakers, and/or screens. In other examples, the recovery service can include sending a field support representative to the vehicle location to represent the vehicle and the autonomous vehicle service provider. In some examples, the recovery service can include a tow truck to tow the vehicle to a service center for repair and/or maintenance. In some examples, after the collision details have been resolved by emergency personnel, the recovery service includes the autonomous vehicle driving to a service center for repair and/or maintenance.

At step 210, a recovery prioritization for the vehicle is determined based on the vehicle recovery event. In general, when a fleet of vehicles is in operation, and multiple vehicles from the fleet are in need of recovery, recovery prioritization includes determining which vehicles to prioritize for recovery. In some examples, vehicles in need of recovery can be ranked. Recovery prioritization is based on the information from vehicle recovery event, such as the type of event and the type of recovery service needed. Additional factors considered in determining recovery prioritization include the presence of passengers in the vehicle, the vehicle location (such as whether it is pulled over or stuck in moving traffic), and the amount of surrounding traffic. In some examples, a severity level (i.e., a risk profile) is associated with the vehicle recovery event, where the severity level can include any potential risks for the vehicle in need of recovery, and the severity level can be used to determine recovery prioritization, such that a vehicle in a riskier location or a vehicle with a passenger is prioritized for recovery over a vehicle in a less risky situation and/or an unoccupied vehicle.

The severity level can be based on a number of factors. Any factor that increases the risk to the vehicle increases the severity level of the vehicle's situation. In some examples, different factors are weighted differently, such that some factors increase the severity level and/or risk level more than other factors. Increasing risk can include increasing the risk another vehicle may collide with the stranded vehicle. Various risk factors can be based on data from hardware sensors, including sensors from the vehicle sensor suite, as well as other external and internal sensors, which may be logged in the vehicle sensor log. One factor used in determining the risk profile is the location of the vehicle. For example, if the first vehicle is stranded in a conflict area, such as in an intersection or in an oncoming traffic lane, the location is considered a high risk location. Similarly, if the first vehicle is stranded in an occluded area after a curve or in a moving traffic lane, the location is a high risk location. The first vehicle location can be determined based on GPS data, mapping and routing data, and vehicle sensor data.

Another factor used in determining the severity level of the vehicle's situation is the lighting conditions of the area. For example, if the vehicle is stranded in a well-lit area, the risk may be considered lower than if the vehicle is stranded in a dark location. Thus, time of day can affect the lighting conditions as well as the presence of artificial lighting. Lighting conditions can be detected by vehicle hardware sensors, including sensors from the vehicle sensor suite, as well as other external sensors, and can be stored in the vehicle sensor log. Similarly, another factor used in determining the severity level of the vehicle's situation is the weather conditions. A vehicle stranded in a very rainy area may be in a higher risk situation than a vehicle stranded in a dry area. Similarly, snow, ice, and wind can affect risk level. For instance, a skid sensor can detect if a road is icy and/or has low traction. This can also be related to the previous factor, such that the weather conditions can affect lighting. Weather conditions can be determined based on data from hardware sensors, including sensors from the vehicle sensor suite, as well as other external sensors, and can be stored in the vehicle sensor log. Additionally, external weather conditions information such as meteorological data can be used in determining both current weather conditions and weather conditions predicted for the near future. Another related factor used in determining the severity level of the vehicle's situation is road conditions. For examples, potholes, icy roads, and other road conditions can affect risk level for the stranded vehicle. In some examples, the weather can be clear, but the roads can be icy. Road conditions can be determined based on data from hardware sensors, including sensors from the vehicle sensor suite, as well as other external sensors, and can be stored in the vehicle sensor log.

Another factor that can used in determining the severity level of the vehicle's situation is the frustration of other road uses. For example, if the vehicle is blocking traffic, this can cause frustration to other road users. Sensors in the vehicle can be used to identify frustration to other road users, and sensors in other vehicles can also be used to identify frustration in nearby road users. Detecting and identifying other road user frustration is described in greater detail in U.S. application Ser. No. 17/557,386, which is hereby incorporated by reference in its entirety.

Another factor that can used in determining the risk profile is nearby traffic conditions. In some examples, a stranded vehicle in a city can cause traffic congestion blocks away. Similarly, a stranded vehicle on a highway can cause miles of traffic congestion. Other vehicles on the roadways can provide feedback on traffic conditions based on vehicle sensor data, which can be used in determining a severity level of the vehicle's situation. In some examples, congestion caused by a stranded vehicle can increase the risk profile ranking (and thus the prioritization) of the stranded vehicle. However, in some examples, because traffic congestion slows down traffic near the vehicle and can thereby reduce the risk to the vehicle itself (as well as reducing risk to other vehicles), the severity level of the vehicle's situation due to traffic congestion can be lower than a severity level of the vehicle's situation with a factor that indicates increased risk of a collision.

Another factor that can be used in determining the severity level of the vehicle's situation is the approximate distance between the stranded vehicle and other road users. This can be sensed by vehicle sensors, such as sensor suite sensors and other external sensors, and stored in the vehicle sensor log. For instance, LIDAR and/or RADAR sensors on a first vehicle can be used to determine the distance between the first vehicle and a second vehicle and/or road user. Similarly, the speed at which nearby road users are driving can be used in determining the risk profile. Thus, if other road users are driving at a high rate a speed a few feet or less from the stranded vehicle, this is a higher risk factor than if other road users are driving at a high rate a speed several yards from the stranded vehicle. Similarly, if other road users are driving at a high rate a speed a few feet or less from the stranded vehicle, this is a higher risk factor than if other road users are driving slowly a few feet or less from the stranded vehicle. In general, this factor incorporates the risk of collision and the time to a collision in the determination of the severity level of the vehicle's situation. The speed of other road users and the distance between the vehicle in need of recovery and other road users can be determined based on data from hardware sensors, including sensors from the vehicle sensor suite, as well as other external sensors, and may be stored in the vehicle sensor log.

Another factor that can be used in determining the severity level of the vehicle's situation is the pedestrian density around the stranded vehicle. In particular, if there are a lot of pedestrians around the vehicle (i.e., a heavy density of pedestrians), this can increase the severity level of the situation for the vehicle. For example, the vehicle can be blocking pedestrian traffic. Additionally, a heavy density of pedestrians increases the likelihood that people may interact with the vehicle, which increases the possibility of damage to the vehicle. The presence of pedestrians as well as the approximate number of pedestrians can be determined based on data from hardware sensors, including sensors from the vehicle sensor suite, as well as other external sensors, and can be stored in the vehicle sensor log.

Another factor that can be considered in determining the severity level of the vehicle's situation is the presence of passengers in the vehicle. In particular, in some examples, recovery of vehicles with passengers can be prioritized over recovery of stranded vehicles without passengers. In general, a vehicle sensor log will include information about the presence of passengers. Additionally, vehicle sensors, including internal vehicle sensors, can be used to detect the presence of passenger and determine the number of passengers. In some examples, recovery of the passengers in the vehicle (e.g., by providing a different vehicle for the passengers) can be performed separately from recovery of the vehicle itself. Another factor that can be considered in determining severity level of the vehicle's situation is the availability of a safe location for passengers to stand and wait for help. For example, vehicle sensors, including sensors from the vehicle sensor suite, as well as other external sensors, can be used to determine if there is a pedestrian walkway, a median, a barrier, a curb, etc. where passengers can wait. In some examples, this information is saved in the vehicle sensor log. Similarly, another factor that can be considered in determining severity level of the vehicle's situation is the ability for pedestrians to safely exit the vehicle. Additionally, another factor that can be considered in determining severity level of the vehicle's situation is whether weather conditions are conducive to passengers being willing to wait outside. For instance, if it is hot, cold, stormy, rainy, or otherwise unpleasant outside, passengers may not be willing to wait outside of the vehicle and/or may be dissatisfied by a long wait.

Another factor that can be considered in determining severity level of the vehicle's situation is the presence of emergency personnel at the location of the stranded vehicle. For example, if police or other emergency personnel have already arrived at the location, this can affect recovery prioritization. The presence of emergency personnel can be determined based on data from hardware sensors, including sensors from the vehicle sensor suite, as well as other external sensors.

Another factor that can be considered in determining severity level of the vehicle's situation is the time since the vehicle was first stranded. In general, it may be preferable to recover vehicles within a selected time period. Additionally, the time of day can be considered in determining the severity level of the vehicle's situation. Similarly, the day of the week can be considered in determining the severity level of the vehicle's situation. In general, in some examples, prioritization can be a function of time. For instance, the severity level can be a function of time such that the severity level increases the longer the vehicle is stranded. In some examples, a stranded vehicle provides up to the minute information about its surroundings and prioritization can be changed as the severity levels of various vehicles' situations change. In some examples, a service level assurance is associated with the event and can dynamically change the prioritization based on the changing severity level. In some examples, the closer to an expected time of retrieval, the higher the prioritization.

In various examples, the recovery prioritization for a fleet of vehicle is automated. In some examples, recovery prioritization can be determined by a central computer in communication with various vehicles in the vehicle fleet. In some examples, recovery prioritization can be determined by a dispatch service in communication with various vehicle in the vehicle fleet.

At step 212, a field support technician is assigned to the vehicle in need of recovery based on the recovery service type and the recovery prioritization. In some examples, the field support technician can include a service technician, a repair technician, a tow truck operator, or another vehicle recovery technician. In some examples, a field support technician is a representative from vehicle fleet service, and in some examples, the field support technician is a third party contractor. In various examples, specialized services are offered in different scenarios, depending on the recovery service identified based on the vehicle recovery event.

In some examples, the field support technician is assigned by a dispatch service. Based on the recovery prioritization, in some examples, the vehicle may have to wait for its assigned field support technician to support the recovery of one or more other vehicles. In some examples, once the field support technician is assigned, dispatch can determine an expected time to resolve the recovery of the vehicle. In some examples, a service level assurance is associated with a particular event and the service level assurance can indicate a severity level associated with the event (i.e., how severe the event is). In some examples, the severity and/or circumstances of the event that triggered the recovery request produce a selected service level assurance threshold, such that a recovery request with a high severity rating has a high service level assurance threshold while a recovery request with a low severity rating has a low service level assurance threshold. In some examples, when scheduling a field support representative for an event, the distance and/or time needed for the field support representative to reach the vehicle needs to meet a selected service level assurance in order for the field support representative to be assigned to the event.

In various examples, the severity level of the vehicle's situation can change over time. For example, if another vehicle is blocking the stranded vehicle and warning other road users of its presence, the risk profile for the stranded vehicle can decrease. Similarly, if police have arrived on the scene of the stranded first vehicle, the severity level of the vehicle's situation can decrease. In various examples, the method 200 can be repeated to update the severity level of the vehicle's situation and its recovery prioritization.

In some implementations, recovery of a stranded vehicle can be split into two stages: passenger recovery and vehicle recovery. In particular, if there are passengers on board a stranded vehicle, ensuring passenger wellbeing is the top priority. Additionally, providing passengers with an opportunity to continue on their ride to their destination can be prioritized when possible.

In some examples, a second vehicle can be used to guide and/or direct a first vehicle back to a facility. For example, if a first vehicle's sensors are degraded, the first vehicle can rely on sensor information and directions from the second vehicle to drive to a repair facility. The second vehicle travels in close proximity to the first vehicle, such that it can guide and direct the first vehicle.

In some examples, an autonomous vehicle fleet may utilize other services and/or external support to aid in recovery. For instance, if no autonomous vehicles are available to transport passengers in a stranded autonomous vehicle, a ridehail service may request another vehicle, such as a taxi, to pick up the passengers. In another example, a ridehail service may request support from a different service and/or a different autonomous vehicle fleet. In some examples, an autonomous vehicle fleet service may call an external towing company to recover a stranded vehicle.

In various examples, vehicle recovery relies on map data to guide other autonomous vehicle to and/or away from stranded vehicles. According to various implementations, map data includes high precision map data. In some examples, high precision maps include layers of information in addition to roadway maps and can be used for routing and directing autonomous vehicles. The layers of information can include data about objects visible from roadways, such as buildings, landmarks, signs, traffic lights, hydrants, roadwork, parked vehicles, etc. The layers of information can also include, for example, expected traffic patterns and/or traffic density at various times of day and on various days of the week. When autonomous vehicles travel around an area, the autonomous vehicles record and provide feedback on the surrounding environment to a central computer. The high precision map is updated to include current environment data, and the updated high precision map can be used by other autonomous vehicles and by augmented reality systems in other autonomous vehicles in generating augmented reality environments. Autonomous vehicles can also record and provide feedback on events that are encountered, such as roadwork, including where and when the events are encountered. The high precision maps can include a layer marking waypoints for various events. Data analysis from previous autonomous vehicle routes can also determine timeframes during which selected events are more likely to occur in selected locations and these locations and times can be avoided to avoid congestion.

Example System for Creating an Autonomous Vehicle Recovery Event

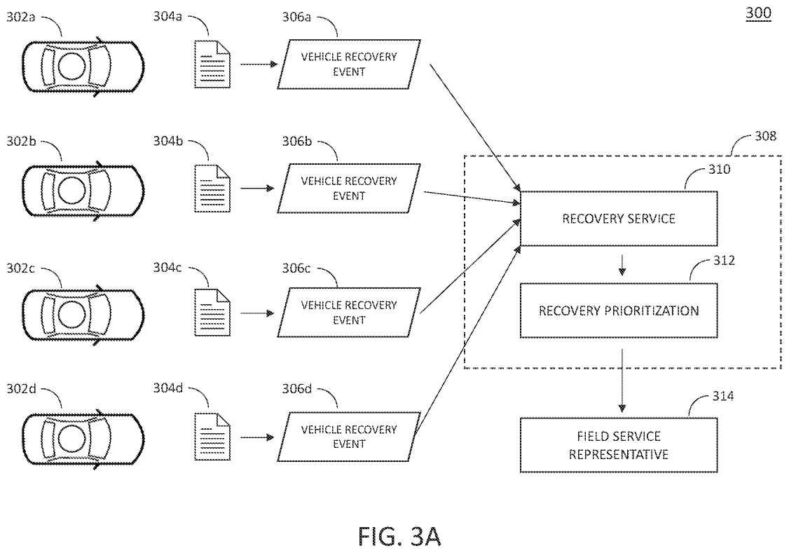

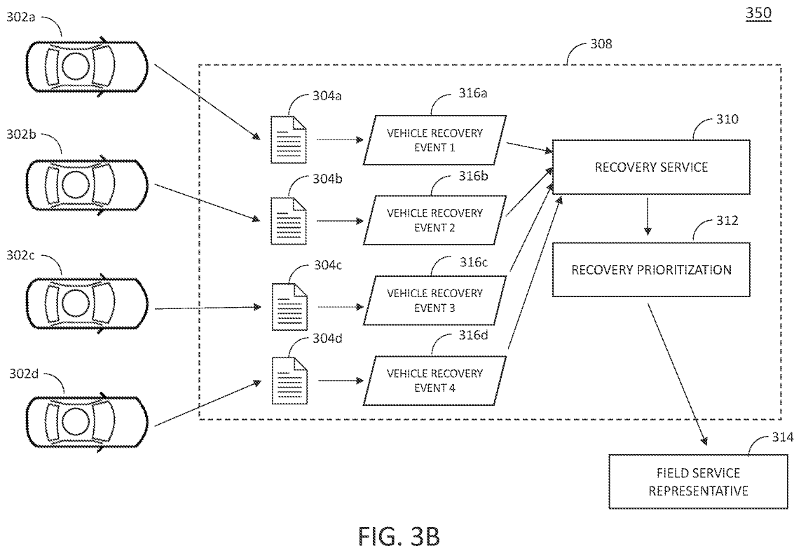

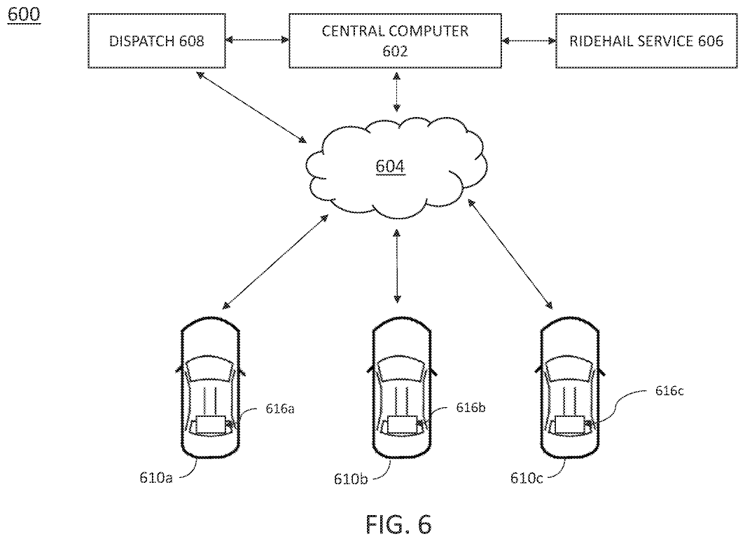

FIGS. 3A and 3B are diagrams illustrating a system for creating vehicle recovery events and for recovery prioritization in a vehicle fleet, according to some embodiments of the disclosure. FIG. 3A is an example in which first 302a, second 302b, third 302c, and fourth 302d fleet vehicles are stranded and in need of recovery, according to various embodiments of the disclosure. Each of the first 302a, second 302b, third 302c, and fourth 302d stranded vehicles has a respective first 304a, second 304b, third 304c, and fourth 304d vehicle sensor log, which is periodically updated with vehicle sensor data, including data from vehicle sensor suites, other external vehicle sensors, and internal vehicle sensors. In some examples, when the first 302a, second 302b, third 302c, and fourth 302d vehicles are operating typically, the respective first 304a, second 304b, third 304c, and fourth 304d vehicle sensor logs are periodically transmitted to a central computer, such as the central computer 602 described below with respect to FIG. 6.

As shown in FIG. 3A, the first 302a, second 302b, third 302c, and fourth 302d vehicles are in need of recovery. The first 302a, second 302b, third 302c, and fourth 302d vehicles each generate first 306a, second 306b, third 306c, and fourth 306d vehicle recovery events based on the respective first 304a, second 304b, third 304c, and fourth 304d vehicle sensor logs. The first 302a, second 302b, third 302c, and fourth 302d vehicles transmit the first 306a, second 306b, third 306c, and fourth 306d vehicle recovery events to a central computer and/or dispatch service 308. The central computer and/or dispatch service 308 identify, based on the first 306a, second 306b, third 306c, and fourth 306d vehicle recovery events, a recovery service 310 for each of the first 302a, second 302b, third 302c, and fourth 302d vehicles.

Based on the recovery service identified for each of the first 302a, second 302b, third 302c, and fourth 302d vehicles, as well as the respective first 306a, second 306b, third 306c, and fourth 306d vehicle recovery events, a recovery prioritization 312 for each of the first 302a, second 302b, third 302c, and fourth 302d vehicles is determined. In some examples, the vehicle with the highest recovery prioritization is prioritized for recovery such that it is recovered first. In some examples, as described above with respect to FIG. 2, the recovery prioritization 312 can be updated over time. For instance, when a new vehicle recovery event it received, the recovery prioritization of the corresponding new vehicle can change the recovery prioritization of other vehicles.

Based on the recovery service 310 and the recovery prioritization 312, a field service representative 314 is assigned to each of the first 302a, second 302b, third 302c, and fourth 302d vehicles. In some examples, a field service representative 314 is assigned to vehicles with a high recovery prioritization ranking first, and vehicles with a lower recovery prioritization ranking wait a field service representative 314.

FIG. 3B is another example in which first 302a, second 302b, third 302c, and fourth 302d fleet vehicles are stranded and in need of recovery, according to various embodiments of the disclosure. As shown with respect to FIG. 3A, each of the first 302a, second 302b, third 302c, and fourth 302d stranded vehicles has a respective first 304a, second 304b, third 304c, and fourth 304d vehicle sensor log, which is periodically updated with vehicle sensor data, including data from vehicle sensor suites, other external vehicle sensors, and internal vehicle sensors. In general operation, the first 304a, second 304b, third 304c, and fourth 304d vehicle sensor logs are periodically transmitted to a central computer, such as the central computer 602 described below with respect to FIG. 6. Additionally, when a vehicle is in need of recovery, the vehicle transmits its sensor log to the central computer and/or dispatch service 308. According to some examples, as shown in FIG. 3B, when a vehicle is in need of recovery, the central computer and/or dispatch service 308 generates a vehicle recovery event from the vehicle sensor log. For examples, for the first 302a, second 302b, third 302c, and fourth 302d vehicles, the central computer and/or dispatch service 308 generates first 316a, second 316b, third 316c, and fourth 316d vehicle recovery events based on the respective first 304a, second 304b, third 304c, and fourth 304d vehicle sensor logs.

The central computer and/or dispatch service 308 identify, based on the first 316a, second 316b, third 316c, and fourth 316d vehicle recovery events, a recovery service 310 for each of the first 302a, second 302b, third 302c, and fourth 302d vehicles. Additionally, the central computer and/or dispatch service 308 determines a recovery prioritization 312 for each of the first 302a, second 302b, third 302c, and fourth 302d vehicles, based on the recovery service identified for each of the first 302a, second 302b, third 302c, and fourth 302d vehicles, as well as the respective first 316a, second 316b, third 316c, and fourth 316d vehicle recovery events. In some examples, the vehicle with the highest recovery prioritization is prioritized for recovery such that it is recovered first. In some examples, as described above with respect to FIG. 2, the recovery prioritization 312 can be updated over time. For instance, when a new vehicle recovery event it received, the recovery prioritization of the corresponding new vehicle can change the recovery prioritization of other vehicles.

Based on the recovery service 308 and the recovery prioritization 312, a field service representative 314 is assigned to each of the first 302a, second 302b, third 302c, and fourth 302d vehicles. In some examples, a field service representative 314 is assigned to vehicles with a high recovery prioritization ranking first, and vehicles with a lower recovery prioritization ranking wait a field service representative 314.

In various examples, in FIGS. 3A and 3B, the central computer and/or dispatch service 308 is shown as a cloud. The cloud can include both a central computer and a dispatch service, or it can include one of a central computer and a dispatch service. The cloud shown in FIGS. 3A and 3B represents a remote centralized service. In some examples, FIG. 6 includes further details regarding a central computer and/or dispatch service.

Example Diagrams of a Vehicle for Recovery Prioritization

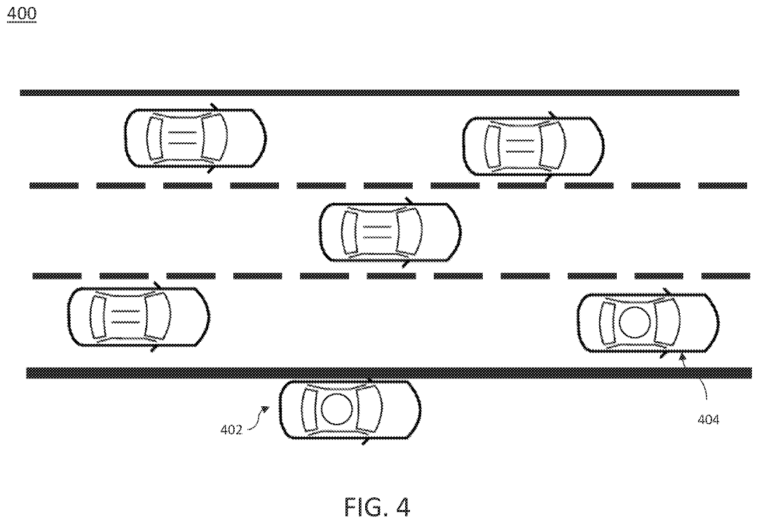

FIG. 4 is a diagram illustrating a stranded vehicle for recovery prioritization, according to various embodiments of the disclosure. In particular, FIG. 4 illustrates a vehicle 402 that is stranded at the side of a multi-lane road. In some examples, the vehicle 402 is on the shoulder of a highway. In other examples, the vehicle 402 is at the side of a city street. There are multiple other vehicles on the road, and, as described above, the speed of the other vehicles as well as the distance of the other vehicles from the stranded vehicle 402 are factors that are considered in determining a severity level of the vehicle's 402 situation (also called a risk profile for the vehicle 402). Additionally, whether the stranded vehicle 402 is causing traffic to build up can be considered, as well as any of the other factors discussed above. The vehicle 402 can provide vehicle sensor logs and/or a vehicle recovery event, which can be used in determining its severity level and/or risk profile, as described above with respect to FIG. 2. In some examples, the vehicle 402 has degraded sensors and/or other components and cannot provide updated information to a central computer or to dispatch, and a last received vehicle sensor log is used to generate a vehicle recovery event for the vehicle. In some examples, passengers can be recovered from a stranded vehicle, such as the vehicle 402, by providing another vehicle for the passengers, and the vehicle 402 can remain awaiting recovery.

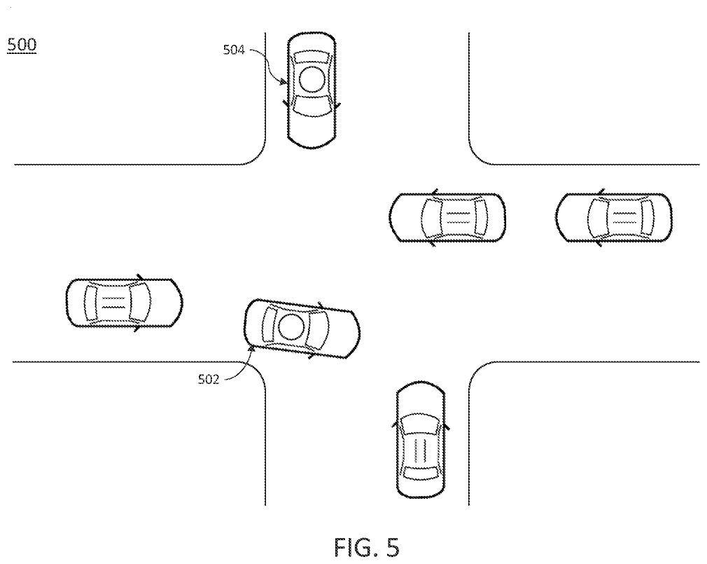

FIG. 5 is another diagram illustrating a stranded vehicle for recovery prioritization, according to various embodiments of the disclosure. In particular, FIG. 5 illustrates a vehicle 502 that is stranded in an intersection. There are multiple other vehicles on the roads in and around the intersection, and, as described above, the stranded vehicle senses information about the other vehicles using its sensor suite and other external sensors and records the information in its vehicle sensor log. The information can include the speed of the other vehicles as well as the distance of the other vehicles from the stranded vehicle 502. The information from the vehicle sensor log is considered in determining a severity level and/or risk profile for the vehicle 502. Additionally, whether the stranded vehicle 502 is causing traffic to build up can be considered, as well as any of the other factors discussed above. The vehicle 502 transmits its vehicle sensor log, which can be used for determining its severity level and/or risk profile, as described above with respect to FIG. 2. Similarly, in some examples, the vehicle 502 generates a vehicle recovery event from its sensor log and transmits the vehicle recovery event. In some examples, the vehicle 502 has degraded sensors and/or other components and cannot provide updated sensor log information to a central computer or to dispatch.

In some examples, if the intersection is in an area with pedestrian walkways and there are passengers in the vehicle 502, passengers can exit the vehicle on the side away from traffic (e.g., from the door on the right hand side). In some examples, the vehicle 502 determines whether and/or when passengers can safely exit the vehicle 502. If passengers exit the vehicle 502, the severity level and/or risk profile for the vehicle 502 can be updated. In some examples, the passengers are prioritized for pick up in a close available autonomous vehicle such that they can continue on to their destination. In some examples, if an emergency vehicle, such as a police car, arrives on the scene, the severity level and/or risk profile for the stranded vehicle can be updated.

Example of Autonomous Vehicle Fleet

FIG. 6 is a diagram 600 illustrating a fleet of autonomous vehicles 610a, 610b, 610c in communication with a central computer 602, according to some embodiments of the disclosure. The vehicles 610a-610c communicate wirelessly with a cloud 604 and a central computer 602. The central computer 602 includes a routing coordinator and a database of information from the vehicles 610a-610c in the fleet. Autonomous vehicle fleet routing refers to the routing of multiple vehicles in a fleet. The central computer also acts as a centralized ride management system and communicates with ridehail users via a ridehail service 606. Via the ridehail service 606, the central computer receives ride requests from various user ridehail applications. Additionally, the central computer communicates with a dispatch service 608. In some implementations, the autonomous vehicles 610a-610c communicate with the dispatch service 608. In some implementations, the autonomous vehicles 610a-610c communicate directly with each other. The autonomous vehicles 610a-610c each include a vehicle sensor log 616a, 616b, 616c as described above with respect to the vehicle sensor log 106 of FIG. 1.

When a ride request is entered at a ridehail service 606, the ridehail service 606 sends the request to the central computer 602. If the ridehail request is for a future date, the central computer 602 stores the information for future routing determinations. In some examples, on the day of the ride request, during a selected period of time before the ride begins, the vehicle to fulfill the request is selected and route for the vehicle is generated by the routing coordinator. In other examples, the vehicle to fulfill the request is selected and the route for the vehicle is generated by the onboard computer on the autonomous vehicle. In various examples, information pertaining to the ride Is transmitted to the selected vehicle 610a-610c. With shared rides, the route for the vehicle can depend on other passenger pick-up and drop-off locations. Each of the autonomous vehicles 610a, 610b, 610c in the fleet record sensor data in a vehicle sensor log. In some examples, each of the autonomous vehicles 610a, 610b, 610c in the fleet is equipped to generate a vehicle recovery event from its respective vehicle sensor log 616a, 616b, 616c in the even the vehicle is in need of recovery. However, in some examples, vehicle sensors and/or other components can be degraded such that the vehicles are unable to record and/or provide updated vehicle sensor logs. The vehicles 610a, 610b, 610c communicate with the central computer 602 via the cloud 604. Similarly, the vehicles 610a, 610b, 610c communicate with the dispatch service 608 via the cloud 604.

In some examples, when one or more vehicles in the fleet is stranded, dispatch 608 can determine a recovery prioritization for recovery of the stranded vehicle(s). In various examples, dispatch can communicate with the central computer 602 and update routes for various vehicles based on recovery prioritization and any other instructions from dispatch.

As described above, each vehicle 610a-610c in the fleet of vehicles communicates with a routing coordinator. Thus, information gathered by various autonomous vehicles 610a-610c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more traveling preferences and/or routing goals. In some examples, a traveling preference includes a request for a longer ride to accommodate planned in-vehicle activities, such as augmented reality experiences. In some examples, the routing coordinator uses collected position data corresponding to emergency events to generate a best route for an autonomous vehicle to avoid a potential emergency situation and associated unknowns.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridehailing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, ridehail revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals takes priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computer 602 generates a route for each selected autonomous vehicle 610a-610c, and the routing coordinator determines a route for the autonomous vehicle 610a-610c to travel from the autonomous vehicle's current location to a first destination.

Example of a Computing System for Ride Requests

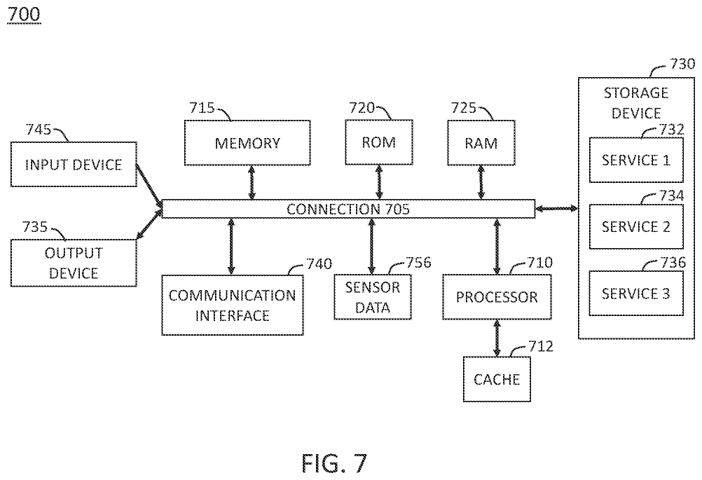

FIG. 7 shows an example embodiment of a computing system 700 for implementing certain aspects of the present technology. In various examples, the computing system 700 can be any computing device making up the onboard computer 104, the central computer 602, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 700 includes at least one processing unit (CPU or processor) 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. In various examples, one or more of the services 732, 734, 736 include vehicle recovery services, vehicle recovery prioritization services, vehicle sensor log services, and/or vehicle recovery event generation services, as described herein. The processor 710 may essentially be a completely self-contained computing system, containing multiple cores or processors, a bus, memory controller, cache, etc. A multi-core processor may be symmetric or asymmetric.

The computing system 700 includes a sensor data 756 input. The sensor data 756 can include a vehicle sensor log, such as the vehicle sensor log 106 of FIG. 1, that stores vehicle sensor data The sensor data 756 from the vehicle sensor log can be transmitted via the connection 705 to other components of the computing system 700. In other examples, sensor data 756 is stored in another location such as in memory 715 and/or in a storage device 730. Sensor data 756 can change frequently as a vehicle drives and its environment changes, and thus the vehicle sensor log can also be frequently updated.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer-readable media which can store data that are accessible by a computer, such as magnetic cassettes, flash memory cards, solid state memory devices, digital versatile disks, cartridges, RAMs, ROMs, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an Internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### SELECT EXAMPLES

Example 1 provides a method for vehicle recovery, comprising: determining a vehicle is in need of recovery; generating a vehicle recovery event based on a vehicle sensor log; determining a recovery service type based on the vehicle recovery event; determining a recovery prioritization for the vehicle based on the vehicle recovery event; and assigning a field support technician based on the recovery service type and the recovery prioritization.

Example 2 provides a method, system, and/or vehicle according to one or more of the preceding and/or following examples, further comprising determining recovery prioritization based on the vehicle sensor log.

Example 3 provides a method, system, and/or vehicle according to one or more of the preceding and/or following examples, wherein the vehicle sensor log includes vehicle sensor data, and further comprising determining a risk profile for the vehicle based on the vehicle sensor data.

Example 4 provides a method, system, and/or vehicle according to one or more of the preceding and/or following examples, wherein the vehicle sensor data includes at least one of a presence of passengers in the first vehicle, a speed of other road users, a distance between the vehicle and other road users, road conditions, and weather conditions.

Example 5 provides a method, system, and/or vehicle according to one or more of the preceding and/or following examples, wherein determining the recovery prioritization includes determining the recovery prioritization based on the risk profile.

Example 6 provides a method, system, and/or vehicle according to one or more of the preceding and/or following examples, wherein determining the recovery prioritization for the vehicle includes determining the recovery prioritization based on the recovery service type.

Example 7 provides a method, system, and/or vehicle according to one or more of the preceding and/or following examples, wherein determining the recovery prioritization for the vehicle includes providing a rank for recovery to each of a plurality of stranded vehicles in a fleet, wherein the vehicle is one of the plurality of stranded vehicles.

Example 8 provides a method, system, and/or vehicle according to one or more of the preceding and/or following examples, wherein generating the vehicle recovery event based on the vehicle sensor log includes generating the vehicle recovery event at an onboard computer on the vehicle, and further comprising transmitting the vehicle recovery event to a dispatch service.

Example 9 provides a method, system, and/or vehicle according to one or more of the preceding and/or following examples, wherein generating the vehicle recovery event based on the vehicle sensor log includes receiving the vehicle sensor log at a central computer, generating the vehicle recovery event at the central computer, and further comprising transmitting the vehicle recovery event to a dispatch service.

Example 10 provides a system for vehicle recovery in a fleet of vehicles, comprising: a first vehicle in the fleet, including: a sensor suite including external vehicle sensors to sense a vehicle environment and generate sensor data; a vehicle sensor log to log sensor data; an onboard computer to transmit the vehicle sensor log; and a dispatch service to: identify a recovery service type for the first vehicle based on a vehicle recovery event; determine a recovery prioritization for the first vehicle based on the vehicle recovery event and the recovery service type; and assign a field support technician based on the recovery service type and the recovery prioritization.

Example 11 provides a method, system, and/or vehicle according to one or more of the preceding and/or following examples, wherein the first vehicle onboard computer is to generate the vehicle recovery event from the vehicle sensor log and transmit the vehicle recovery event to the dispatch service.

Example 12 provides a method, system, and/or vehicle according to one or more of the preceding and/or following examples, further comprising a central computer to receive the vehicle sensor log, generate the vehicle recovery event based on the vehicle sensor log, and transmit the vehicle recovery event to the dispatch service.

Example 13 provides a method, system, and/or vehicle according to one or more of the preceding and/or following examples, wherein the vehicle sensor data includes at least one of a presence of passengers in the first vehicle, a speed of other road users, a distance between the vehicle and other road users, road conditions, and weather conditions.

Example 14 provides a method, system, and/or vehicle according to one or more of the preceding and/or following examples, wherein the dispatch service is further to determine a risk profile for the first vehicle based on the vehicle sensor data and wherein the recovery prioritization is based on the risk profile.

Example 15 provides a method, system, and/or vehicle according to one or more of the preceding and/or following examples, wherein the dispatch service is further to provide a rank for recovery to each of a plurality of stranded vehicles in the fleet, wherein the first vehicle is one of the plurality of stranded vehicles.

Example 16 provides a system for system for vehicle recovery in a vehicle fleet, comprising: a plurality of vehicles, each vehicle including: a sensor suite including external vehicle sensors to sense a vehicle environment and generate sensor data; a vehicle sensor log to log sensor data; an onboard computer to transmit the vehicle sensor log; and a dispatch service to: identify a recovery service type for each of a set of stranded vehicles, wherein the recovery service type is based on a vehicle recovery event for each of the set of stranded vehicles, and wherein the plurality of vehicles includes the set of stranded vehicles; determine a recovery prioritization based on the respective vehicle recovery event for each of the set of stranded vehicles; and assign a field support technician to each of the set of stranded vehicles based on the recovery service type and the recovery prioritization.

Example 17 provides a method, system, and/or vehicle according to one or more of the preceding and/or following examples, wherein, for each of the set of stranded vehicles, the onboard computer is to generate the vehicle recovery event based on the vehicle sensor log.

Example 18 provides a method, system, and/or vehicle according to one or more of the preceding and/or following examples, further comprising a central computer to, for each of the set of stranded vehicles, receive the vehicle sensor log, generate the vehicle recovery event based on the vehicle sensor log, and transmit the vehicle recovery event to the dispatch service.

Example 19 provides a method, system, and/or vehicle according to one or more of the preceding and/or following examples, wherein the dispatch service is further to provide a rank for recovery to each of the set of stranded vehicles, and wherein the recovery prioritization is based on the rank.

Example 20 provides a method, system, and/or vehicle according to one or more of the preceding and/or following examples, wherein, for each of the plurality of vehicles, the sensor data includes at least one of a presence of passengers in the respective vehicle, a speed of other road users around the respective vehicle, a distance between the respective vehicle and other road users, road conditions, and weather conditions at the respective vehicle, and wherein the dispatch service is further to determine a risk profile for each of the set of stranded vehicle based on the respective sensor data.

Example 21 provides a method, system, and/or vehicle according to one or more of the preceding and/or following examples, wherein the recovery prioritization is based on the risk profile.

Example 22 provides a method for vehicle recovery, comprising: determining by a vehicle that the vehicle is in need of recovery; generating a vehicle recovery event based on a vehicle sensor log; transmitting the vehicle recovery event to a central computer.

Example 23 provides a method, system, and/or vehicle according to one or more of the preceding and/or following examples, further comprising determining a risk profile for the vehicle based on the vehicle recovery event.

Example 24 provides a method, system, and/or vehicle according to one or more of the preceding and/or following examples, further comprising determining a risk profile for the vehicle based on the vehicle sensor log.

Example 25 provides a method, system, and/or vehicle according to one or more of the preceding and/or following examples, further comprising determining a recovery prioritization for the vehicle based on the risk profile.

Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, or one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for vehicle recovery, comprising:
determining a vehicle is in need of recovery;
receiving a vehicle recovery event generated based on a vehicle sensor log,
determining a recovery service type based on the vehicle recovery event;
determining a recovery prioritization for the vehicle based on the vehicle recovery event; and
assigning a field support technician based on the recovery service type and the recovery prioritization.

2. The method of claim 1, further comprising determining recovery prioritization based on the vehicle sensor log.

3. The method of claim 2, wherein the vehicle sensor log includes vehicle sensor data, and further comprising determining a risk profile for the vehicle based on the vehicle sensor data.

4. The method of claim 3, wherein the vehicle sensor data includes at least one of a presence of passengers in the vehicle, a speed of other road users, a distance between the vehicle and other road users, road conditions, and weather conditions.

5. The method of claim 3, wherein determining the recovery prioritization includes determining the recovery prioritization based on the risk profile.

6. The method of claim 1, wherein determining the recovery prioritization for the vehicle includes determining the recovery prioritization based on the recovery service type.

7. The method of claim 1, wherein determining the recovery prioritization for the vehicle includes providing a rank for recovery to each of a plurality of stranded vehicles in a fleet, wherein the vehicle is one of the plurality of stranded vehicles.

8. The method of claim 1, wherein generating the vehicle recovery event based on the vehicle sensor log includes generating the vehicle recovery event at an onboard computer on the vehicle, and further comprising transmitting the vehicle recovery event to a dispatch service.

9. The method of claim 1, wherein generating the vehicle recovery event based on the vehicle sensor log includes receiving the vehicle sensor log at a central computer, generating the vehicle recovery event at the central computer, and further comprising transmitting the vehicle recovery event to a dispatch service.

10. A system for vehicle recovery in a fleet of vehicles, comprising:
a first vehicle in the fleet, including:
a sensor suite including external vehicle sensors to sense a vehicle environment and generate sensor data;
a vehicle sensor log to log sensor data;
an onboard computer to transmit the vehicle sensor log; and
a dispatch service to:
identify a recovery service type for the first vehicle based on a vehicle recovery event;
determine a recovery prioritization for the first vehicle based on the vehicle recovery event and the recovery service type; and
assign a field support technician based on the recovery service type and the recovery prioritization.

11. The system of claim 10, wherein the onboard computer of the first vehicle is to generate the vehicle recovery event from the vehicle sensor log and transmit the vehicle recovery event to the dispatch service.

12. The system of claim 10, further comprising a central computer to receive the vehicle sensor log, generate the vehicle recovery event based on the vehicle sensor log, and transmit the vehicle recovery event to the dispatch service.

13. The system of claim 10, wherein the vehicle sensor data includes at least one of a presence of passengers in the first vehicle, a speed of other road users, a distance between the vehicle and other road users, road conditions, and weather conditions.

14. The system of claim 13, wherein the dispatch service is further to determine a risk profile for the first vehicle based on the vehicle sensor data and wherein the recovery prioritization is based on the risk profile.

15. The system of claim 10, wherein the dispatch service is further to provide a rank for recovery to each of a plurality of stranded vehicles in the fleet, wherein the first vehicle is one of the plurality of stranded vehicles.

16. A system for vehicle recovery in a vehicle fleet, comprising:
a plurality of vehicles, each vehicle including:
a sensor suite including external vehicle sensors to sense a vehicle environment and generate sensor data;
a vehicle sensor log to log sensor data;
an onboard computer to transmit the vehicle sensor log; and
a dispatch service to:
identify a recovery service type for each of a set of stranded vehicles, wherein the recovery service type is based on a vehicle recovery event for each of the set of stranded vehicles, and wherein the plurality of vehicles includes the set of stranded vehicles;
determine a recovery prioritization based on the respective vehicle recovery event for each of the set of stranded vehicles; and
assign a field support technician to each of the set of stranded vehicles based on the recovery service type and the recovery prioritization.

17. The system of claim 16, wherein, for each of the set of stranded vehicles, the onboard computer is to generate the vehicle recovery event based on the vehicle sensor log.

18. The system of claim 16, further comprising a central computer to, for each of the set of stranded vehicles, receive the vehicle sensor log, generate the vehicle recovery event based on the vehicle sensor log, and transmit the vehicle recovery event to the dispatch service.

19. The system of claim 16, wherein the dispatch service is further to provide a rank for recovery to each of the set of stranded vehicles, and wherein the recovery prioritization is based on the rank.

20. The system of claim 16, wherein, for each of the plurality of vehicles, the sensor data includes at least one of a presence of passengers in the respective vehicle, a speed of other road users around the respective vehicle, a distance between the respective vehicle and other road users, road conditions, and weather conditions at the respective vehicle, and wherein the dispatch service is further to determine a risk profile for each of the set of stranded vehicle based on the respective sensor data.
